(19) United States
(12) Patent Application Publication
(10) Pub. No.: US 2005/0242279 A1
(43) Pub. Date: Nov. 3, 2005

(54) Tandem time of flight mass spectrometer and method of use

(75) Inventor: Anatoli N. Verentchikov, St. Petersburg (RU)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Leco Corporation, St. Joseph, MI (US)

(21) Appl. No.: 10/520,871

(22) PCT Filed: Apr. 29, 2003
(86) PCT No.: PCT/US03/13262

§ 371 Date: Jan. 11, 2005

(30) Foreign Application Priority Data
Jul. 16, 2002 (GB) 0216438.2

(51) Int. Cl. H01J 49/40

(52) U.S. Cl. 250/287

(57) ABSTRACT

To provide comprehensive (i.e. rapid and sensitive) MS-MS analysis, the inventor employs a time-nested separation, using two time-of-flight (TOF) mass spectrometers. Parent ions are separated in a slow and long TOF1, operating at low ion energy (1 to 100 eV), and fragment ions are mass analyzed in a fast and short TOF2, operating at much higher keV energy. Low energy fragmentation cell between TOF1 and TOF2 is tailored to accelerate fragmentation and dampening steps, mostly by shortening the cell and employing higher gas pressure. Since separation in TOF1 takes milliseconds and mass analysis in TOF2—microseconds, the invention provides comprehensive MS-MS analysis of multiple precursor ions per single ion pulse. Slow separation in TOF1 becomes possible with an introduction of novel TOF1 analyzers. The TOF-TOF could be implemented using a static TOF1, here described on the examples of spiratron, planar and cylindrical multi-pass separators with griddles spatial focusing ion mirrors. Higher performance is expected with the use of novel hybrid TOF1 analyzers, combining radio frequency (RF) and quadratic DC fields. RF field retains low-energy ions within TOF1 analyzer, while quadratic DC field improves resolution by compensate for large relative energy spread.

### FIELD OF THE INVENTION

The invention relates to the area of mass spectrometry, and more in particularly is concerned with a method of high-throughput, comprehensive tandem mass spectrometry in apparatus, including two time-of-flight mass spectrometers.

### BACKGROUND OF THE INVENTION

Mass spectrometers are devices which vaporize and ionize a sample and then use static or dynamic electric fields to measure the mass-to-charge ratios of the ions formed. Tandem mass spectrometry is used for structural analysis and the identification of compounds in complex mixtures. In every application the MS-MS procedure has the same sequence of operations:
Mass selection of parent ions of a single mass-to-charge ratio (m/z);
Fragmentation of those ions;
Mass analysis of the fragments.
   Though there is a large variety of tandem MS-MS instruments with their own strength and weakness, all of them have one common feature—all of them use one parent ion at a time. The rest of ion species are removed out of the primary ion beam and lost.

Triple quadrupole instrument is the most common MS-MS instrument. Continuous ion source, like e.g. electrospray (ESI), introduces ions into a first quadrupole mass filter, which is tuned, such that only ions-of-interest pass the mass filter. The rest of primary beam components are rejected and lost. Selected ions are transmitted into a so-called ‘collision induced dissociation’ (CID) cell, filled with gas at mTorr pressure and equipped with a radio frequency (RF) quadrupole guide. The kinetic energy of injected ions is controlled by electrostatic bias of mass filter and it is adjusted to induce ion fragmentation via gas collisions. Fragment ions are collisional dampened in CID cell and then introduced into a second quadrupole for mass analysis. Since mass scanning in a second quadrupole takes time and causes additional ion losses by factor of c.a. 1000, triple quadrupole instruments are mostly used for detection of known species with known masses of parent and fragment ions.

Introduction of quadrupole-time-of-flight tandem mass spectrometers (Q-TOF) strongly enhanced throughput of MS-MS instruments (see Morris et.al. Rapid Commun. Mass Spectrom. v.10, pp.889-896, 1996). The triple quadrupole was modified, such that second quadrupole mass filter was replaced by an orthogonal TOF MS (oa-TOFMS). This substitution gave an advantage of parallel analysis of all fragment at once and, hence, higher sensitivity and faster acquisition in a second MS, as well as enhanced resolution and mass accuracy of second MS. However, quadrupole is still used for parent ion selection, accompanied by rejection of all ion species but one. The idea of parallel analysis has not been extended onto parent ions.

Another common MS-MS device uses Paul ion trap mass spectrometer (ITMS), well described in March, R. E., Hughes R, J. Quadrupole storage mass spectrometry, Willey-Interscience, New York 1989. Ions, produced in the ion source, are periodically injected into an ITMS and are trapped within the ITMS by radio-frequency (RF) field. ‘Unwanted’ species are removed by e.g. applying a broadband resonant AC signal, so that only ions-of-interest remain in the trap. Selected parent ions are then excited by a separate AC field, resonant with the secular motion of the precursor. Parent ions gain kinetic energy and fragment in energetic collisions with a buffer gas. Fragments are mass analyzed using a resonant ejection technique. The amplitude of RF field is ramped such that ions leave the trap sequentially according to their m/z values.

It also has been known to couple 3-D Paul trap with a TOF analyzer for more accurate mass analysis of fragment ions, see Quin and D. Lubman, Rap. Commun. Mass. Spectrom. 10, 1079, 1996 and WO 099/39368 by Shimadzu. Linear ion trap (LIT) has been coupled to TOF analyzer in U.S. Pat. No. 5,847,386 by D. Douglas, in U.S. Pat. No. 6,111,250 by Sciex; in U.S. Pat. No. 6,020,586 by Analytica and in WO 01/15201 by U of New Hampshire. All ion trap tandems are mostly oriented on multiple stage MS-MS analysis. Parent ions are selected with a loss of other ion components.

Recently introduced tandem time-of-flight mass spectrometers (TOF-TOF) are the closest prototypes to the below described invention by similarity of employed hardware. Examples of TOF-TOF are described in U.S. Pat. No. 5,032,722 by Schlag et.al., U.S. Pat. No. 5,464,985 by T. J. Kornish et.al., U.S. Pat. No. 5,854,485 by T. Bergmann, U.S. Pat. No. ______ WO99/40610 by M. L. Vestal and in WO99/01889 by C. Hop. In all TOF-TOF tandems, a pulsed ion beam is time separated in a first, high-energy TOF and filtered by timed ion selector, so that only ions-of-interest pass into CID cell. The CID cell is filled with gas at a low gas pressure (usually below 1 mtorr) to introduce nearly single high energy collision with buffer gas, sufficient for ion fragmentation, but still retaining short duration of ion packet. A pulsed beam of fragment ions is analyzed in a second, high energy TOF. To handle large energy spread of fragment ions, second TOF employs either quadratic field potential or an additional pulsed acceleration.

In WO 00/77823 by A. Verentcfikov, a variation of TOF-TOF tandem employs slow injection of parent ions into a CID cell with collisional dampening of fragments and subsequent injection into an orthogonal TOF. The instrument is the closest prototype of the invention, considering employed components. Collisional dampening in the fragmentation cell improves ion beam characteristics in-front of the second TOF and allows high resolution and accurate measurements of fragment ion masses. The first TOF operates at 1 kV energy and a short time scale. Time gate in front of CID cell admits only one parent ion mass at a time.

In all described tandems the first mass analyzer (either quadrupole, ion trap or TOF) selects one parent mass in a time and rejects all other components. In some applications, like drug metabolism studies, it is acceptable to follow a single compound of interest. In the case of complex mixtures (like protein characterization out of gels), however, it is necessary to analyze multiple parent ions. Using existing techniques, sequential MS-MS analysis of multiple precursors is tedious and insensitive.

Recently introduced tandem IMS-CID-TOF, employs principle of time-nested acquisition, potentially to be implemented without ion losses, WO 00/70335 by D. Clemmer. Since separation in ion mobility spectrometer (IMS) occurs in millisecond time scale and TOF mass spectrometry—in microsecond scale, it become possible to acquire fragment spectra for each ion mobility fraction. The disadvantage of the technique is a poor IMS separation with mobility resolution below R=50, which corresponds to mass resolution of about 10. Since, IMS-TOF tandem employs a principle of comprehensive tandem mass spectrometry with time-nested acquisition, it is selected as a prototype of the invention.

The idea of MS-MS analysis without parent ion losses is also used in WO 01/15201 by B. Reinhold and A. Verentchikov. Ions are selected by resonant excitation and moved between ion traps without rejecting other ionic components. The procedure is tedious and takes long time, while ions coming from the ion source are lost. So-called parallel ion processing is employed in multiple ion traps in WO92/14259 by Kirchner, where the beam is split between multiple traps. Time is saved by loosing sensitivity.

There is still a need for an instrument providing rapid and sensitive MS-MS analysis for multiple parent ions in parallel without rejecting ions coming out of ion source. Such instrument would further improve a throughput of MS-MS analysis, desirable in analysis of complex mixtures.

### SUMMARY OF THE INVENTION

The present inventor has realized, that one can implement the principle of nested time separation using two time-of-flight (TOF) mass spectrometers—slow TOF1 for parent ion separation and fast TOF2 for fragment mass analysis. Thus, general method of tandem mass spectrometry of the invention employs two time of flight separations, wherein for the same mass-to-charge ratio, flight time in the first separation step is much longer than flight time in the second separation step and multiplicity of parent ions are separated, fragmented and mass analyzed per single ion injection out of ion source.

Tandem mass spectrometer of the invention comprises a pulsed ion source, a time-of-flight mass spectrometer (TOF1) for time separation of parent ions, a fragmentation cell, a second time-of-flight mass spectrometer (TOF2) for mass analysis of fragment ions and a data acquisition system. Contrary to prototype TOF-TOF systems, flight time in the TOF1 is substantially larger than both passage time through fragmentation cell and flight time in the TOF2. Prolonged separation in TOF1, typically in millisecond range, could be achieved by operating longer TOF1 at much lower kinetic energy, typically around 1 to 100 eV, while using shorter TOF2 at 3 to 10 keV energy. Time between arrival of adjacent parent ion species becomes sufficient to fragment and mass analyze fragments. Thus, the invention allows rapid MS-MS analysis of multiple parent ions in real time without rejecting parent ions. The MS-MS acquisition cycle lasts few milliseconds and can be repeated multiple times to improve sensitivity and signal quality.

To avoid ion losses the ion source is operated in a pulsed mode at about 100 Hz repetition rate, compatible with millisecond time of MS-MS cycle. Matrix Assisted Laser Desorption/Ionization (MALDI) ion source is one example of usable pulsed ion source. The invention is also compatible with a wide variety of continuous ion sources, like ESI, MALDI with gas cooling, Chemical Ionization and gas filled Photo-ionization ion sources. Ion flow is continuously accumulated within storage radio frequency (RF) device and is periodically pulse ejected into the TOF1. The said storage device can be either Paul trap or storage multipole, preferably quadrupole.

To the best knowledge of the author, the novel time-nested TOF-TOF method can not be implemented on existing TOF-TOF instruments without severe sacrifice of performance. The invention discloses five novel TOF1 separators, operating at low ion energy (1 to 100 eV) to expand separation time.

Two of those novel TOF1 analyzers employ combination of confining radio frequency (RF) field with DC quadratic field, providing temporal focusing of ion beam with a large relative energy spread. Those analyzers are capable of operating at particularly low ion energy from 1 to 10 eV. In one preferred embodiment, the novel TOF1 analyzer comprises a linear multipole ion guide, preferably quadrupole, surrounded by DC mirrors. DC mirrors on both ends are turned on and off to provide ion injection from one TOF1 end, multiple ion reflections and subsequent ion release from another end. In another preferred embodiment, the novel TOF1 analyzer comprises two external rows of DC electrodes and two internal rows of RF-only rods, oriented across TOF1 axis. The structure forms two dimensional RF-tunnel combined with quadratic potential distribution along the TOF axis. Ions are injected into the TOF1 at small angle to the axis, experience multiple reflections along the axis, slowly shift across the axis and leave TOF1 after several reflections.

Another three novel analyzers are electrostatic devices, operating at medium energy around 100 eV. One of them, ‘spiratron’ comprises a pair of coaxial cylindrical electrodes with DC voltage applied between them. Ions are injected between said electrodes at small angle to their axis. Medium energy (100 eV) ions turn around central electrode while drifting slowly along the axis. After a number of turns ions leave TOF1 through a cut-off boundary, which is formed by double sided printed circuit board to avoid DC field disturbance. Other two electrostatic separators are planar and cylindrical multi-pass analyzers, employing griddles mirrors, simultaneously acting like a lens. Effective flight path is extended by use of a multi-pass mode, so that 10 ms time scale is achieved in-spite of a higher energy (compared to RF assisted TOF1).

The invention is compatible with variety of fragmentation methods—in gas collisions, in collisions with surface and by light. The design of fragmentation cells is trimmed to reduce transmission time and time spread. CID cell is chosen short (around 1 cm), filled with gas at relatively high pressure (above 0.1 mbar) and supplemented by axial DC field to accelerate transmission and to modulate ion beam synchronous with TOF2. The surface induced dissociation (SID) cell uses pulsed lens to provide spatial focusing together with temporal focusing (bunching). Ions are ejected out of SID cell by pulsing probe potential, synchronized (though with time shift) with bunching lens and TOF2 pulses.

Though, choice of second time-of-flight analyzer is not critical, the TOF with orthogonal ion injection (o-TOF) is more suitable in majority of tandem examples. In order to improve efficiency of orthogonal injection (so-called duty cycle), it is preferred to eject ions out of fragmentation cell synchronous and slightly prior to orthogonal injection pulses.

The TOF-TOF tandem is expected to separate parent ions at moderate resolution, mostly limited by speed of second TOF MS, e.g. 10 us. The estimated resolution of TOF1 in the order of 300 (see detailed description) is still sufficient to isolate a group of isotopes of parent ions and is much higher than resolution of parent separation in ion mobility spectrometer—a prototype of the invention. Higher resolution of separation could be achieved in longer TOF1, or by periodic selection of ions by time gate in front of CID cell.

The invention allows multiple strategies of data acquisition. In a simplest and robust approach, MS-MS data are acquired continuously and MS-MS spectra of multiple parent ions are reconstructed afterwards. It is wiser, though, to perform MS-MS analysis in two stages. At first, MS-only stage, parent ions are continuously admitted into TOF2 for mass analysis of parent ions. Information on masses of parent ions is used for a second MS-MS stage. Time gate opens only at time of arrival of multiple parents of interest to improve resolution of parent ion separation and to avoid signal from chemical background. TOF2 signal is also acquired for selected time windows only to reject meaningless data flow. Similar information on parent ions may be obtained using an optional on-line detector located anywhere after TOF1.

In addition to highly sensitive and rapid MS-MS analysis the invention provides multiple types of MS-only analysis. TOF1 alone can be used for MS only analysis for a sake of spreading peaks in time, avoiding detector saturation and using inexpensive and slow transient recorder. Better quality spectrum of parent ions could be acquired in TOF2 while using TOF1 in a pass mode. So-called “Parent scan”, i.e. spectrum of parent ions having a set of specific fragments, can be reconstructed from MS-MS data, averaged in multiple source injections. The data could be finally stored for parents masses only.

Since MS/MS spectra are acquired for all precursor ions of interest in a single ion injection, the invention provides an exceptional speed of MS/MS analysis, estimated as 10 to 30 full cycles a second. The speed of MS-MS analysis is compatible with time scale of chromatographic separation, thus, a real time LC-MS-MS analysis is possible without any prior limitations, such as “data dependent acquisition”, currently employed in ion traps and Q-TOF. High acquisition speed and sensitivity of the invented MS-MS tandem also opens an opportunity for using nested LC-LC analysis up-front.

### BRIEF DESCRIPTION OF THE DRAWINGS

This invention is pointed out with particularity in the appended claims. The above and further advantages of this invention may be better understood referring to the following description taken in conjunction with the accompanying drawings in which:

FIG. 1 is a block diagram, illustrating the method of the invention.

FIG. 2 is a timing diagram of operation of tandem TOF-TOF mass spectrometer.

FIG. 3 is a schematic of novel in-line TOF1.

FIG. 4 is a schematic of novel W-shape TOF1.

FIG. 5 is a schematics of vacuum pulsed MALDI ion source.

FIG. 6 is a schematic of pulsed MALDI ion source with collisional dampening.

FIG. 7 is a schematics of continuous ion source with pulsing storage quadrupole.

FIG. 8 is a schematic of CID cell.

FIG. 9 is a schematic of SID cell.

FIG. 10 is a schematic of orthogonal TOF2.

FIG. 11 is a schematic of coaxial TOF2

FIG. 12 is a schematics of TOF-TOF with in-line TOF1 and CID cell.

FIG. 13 is a schematics of TOF-TOF with W-shape TOF1 and SID cell.

FIG. 14 is a schematic of TOF-TOF with static coaxial TOF1.

FIG. 15 is a schematic of planar electrostatic multi-pass TOF1.

FIG. 16 is a schematics of cylindrical electrostatic multi-pass TOF1.

### DETAILED DESCRIPTION OF THE INVENTION

Method

A method of tandem mass spectrometry analysis of the invention comprises the steps of:
1. generating an ion pulse in an ion source, containing a mixture of different analyte ions;
2. separating analyte ions in time within a first time-of-flight mass spectrometer, operating at low energy, and, thus, generating a train of ion packets in a sequence of their masses,
3. sequentially fragmenting analyte ions without mixing said separated ion packets;
4. rapidly mass analyzing fragment ions within a second time-of-flight mass spectrometer at a time scale much shorter, than time scale of the first separation step;
5. acquiring fragment mass spectra for multiple analyte ion mass-to-charge ratios at a single ion pulse out of the ion source, and
6. optionally, summing the fragment spectra for each analyte ions over multiple source pulses.
7. The key of the method is arranging separation time in the first TOF much longer than fragmentation time and time of fragment mass analysis for the same mass-to-charge ratio. Substantial difference in time scales is utilized to separate, fragment and mass-analyze fragments for multiplicity of parent ions per single ion injection out of the ion source. Substantial difference in time scale is achieved by selecting longer flight path and/or lower ion energy in the first TOF.

Block Diagram

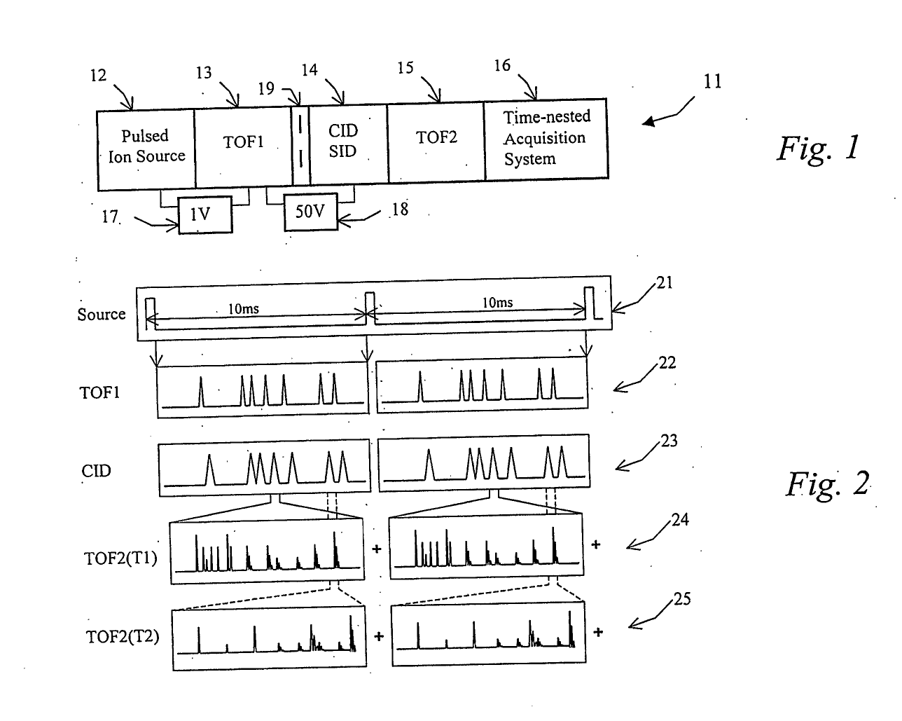

Referring to FIG. 1, the method is illustrated by a block diagram of major tandem MS-MS components. The generic TOF-TOF instrument with time-nested acquisition (11) comprises sequentially communicating pulsed ion source (12), a first time-of-flight mass spectrometer—TOF1 (13), a fragmentation cell—CID/SID (14), a second time-of-flight mass spectrometer TOF2 (15) and a data system (16) for time-nested acquisition. The pulsed ion source is biased compared to the TOF1 spectrometer at a small potential difference by voltage supply (17), and the TOF1 is biased compared to the CID cell at potential difference by voltage supply (18). An optional timed gate (19) may be inserted between the TOF1 (13) and the CID cell (14) to enhance TOF1 separation.

Operation

Briefly, in operation, the pulsed ion source generates an ion pulse of analyte (parent) ions and injects ions into the TOF1 at a small energy, between 1 to 10 eV, controlled by a voltage supply (17). This is the key difference between the current invention and a prior art, since TOF spectrometers are usually operated at energies between 3 and 30 keV. Separation in TOF1 occurs in several milliseconds. As a guiding example let us consider effective length of TOF1=8 m, ions energy E=3 eV and ion mass m=1000 a.u. In such example ion velocity is V=800 m/s and flight time is 10 ms. Time separated parent ions are sequentially ejected out of TOF1 into the CID cell at an increased energy, controlled by DC bias between TOF1 and the cell. Energetic collisions with gas molecules convert parent ions into fragments. Subsequent gas collisions cause collisional dampening of fragment ions. Fragments rapidly travel through the cell and are injected into the TOF2 spectrometer. TOF2 separates fragment ions at a much shorter time scale, between 10 and 100 us. Drastic difference in time scales of TOF1 and TOF2 allows data acquisition of multiple fragment spectra, corresponding to different parent ions between source pulses. The specialized data acquisition system (16) acquires multiple fragment spectra in a time-nested fashion, where individual spectra are not mixed together. Fragment spectra for each parent ion are integrated over a number of ion source pulses. Thus, ion pulse, generated in the ion source, is used for acquiring a full set of MS-MS data for multiple parents without rejecting ions at all stages.

Time Diagram

Referring to FIG. 2, a typical time diagram illustrates the method of the invention, synchronization of individual devices and a principle of time-nested data acquisition. The top graph (21) presents an acquisition cycle, where ion injections occur every 10 ms, i.e. 100 times a second. Parent ions are separated in the TOF1 within 10 ms time, and the CID cell receives a train of ion packets, aligned in accordance with parent ion mass, graph (22). Parent ions are partially fragmented in the cell, and because of a short transmission time in the cell, fragments arrive to the TOF2 almost simultaneously with their parents, graph (23). Each new family of ions (i.e. parents and daughters) is orthogonal pulsed into the high energy TOF2 every 10 us, producing TOF2 spectra for each parent mass—graph (24). Each TOF2 spectrum obtains a time tag of TOF2 pulse relative to source pulse, i.e. TOF1 time tag. The spectra with the same TOF1 time tag are, summed over multiple ion source pulses, as shown by dashed lines, connecting two TOF2 spectra with the same TOF1 time tag.

Robust Mode

In the above described operation mode, the time-nested acquisition is done in a straightforward way. Instrument operation parameters remain the same, regardless of the ion beam composition out of the ion source, and data are acquired all the time. All the information, like parent ion spectra and fragment spectra for various parents, is extracted in a subsequent data analysis.

Data Dependent Acquisition—DDA

In another operation mode, which should be called ‘data dependent acquisition’, MS-MS analysis occurs in two steps. On the first step, mass spectrum of parents is acquired in a TOF2, while TOF1 and CID cell pass ions continuously without fragmentation. On the second step, the instrument is operated as MS-MS, i.e. the TOF1 separates parent ions, the fragmentation cell forms fragments, the TOF2 acquire fragment mass spectra in the time-nested data fashion. The time-nested acquisition is enhanced by utilizing the information on parent ion masses and avoiding data acquisition at blank times, when no parents are coming. An optional timed gate (19) may be used to enhance TOF1 separation as well as suppression of chemical noise. It is naturally expected, that ion packets coming out of TOF1 are shorter, than the same ion packet at the exit of the CID cell. The timed gate admits ions only at multiple narrow time windows, corresponding to arrival of parent ions. Such gating suppresses ion signal coming from chemical background and improves detection limit. Gate operation may also be used to enhance separation of pair of parent ions of close mass by sacrificing sensitivity. Several sets of MS-Ms data are acquired, while timed gate admits only one parent mass of a pair in a time.

Having described general method, and for the purpose of clarity, the detailed embodiments will be first discussed on the level of individual components and only then presented as examples of integrated TOF-TOF apparatus. Though, some employed components are well known in the art, their configuration and parameters are altered to suit purposes of the invention. To understand selected compromises, let us first look at major challenges in TOF-TOF method and apparatus.

General Objection

The method of the invention is highly counterintuitive, since it would be referred as undoable for multiple reasons. One skillful in the art would object that:
1. TOF1 resolution would be extremely low; since ion energy spread in the source is comparable to ion energy in the TOF1;
2. TOF1 resolution would also suffer because of a large turn around time (time spread, caused by initial velocity spread) in a weak accelerating field;
3. Ion losses through the TOF1 are expected to be devastating, because of expected large length of TOF1, and because of high divergence of slow ion beam in the TOF1;
4. Ion losses are expected to be even higher, since vacuum stage of TOF1 and gas filled CID cell should be separated by a small aperture;
5. It also looks unlikely to have quick transmission through the CID cell in the time scale of 10 to 100 us. Most existing CID cells have 200 to 10,000 us time spread;
6. None of commercial data acquisition system, currently employed in TOF technology, is capable of handling expected data flow rate.

The above objections are mostly concentrated around TOF1 and arise from knowledge on existing TOF mass spectrometers, operating at high energy. The inventor has realized that multiple schemes of TOF1 are capable of slow separation with moderate resolution. Improvement of TOF1 resolution is made by employing an ion mirror with quadratic potential distribution, known to compensate for energy spread. The phenomenon is similar to elastic oscillations, where period does not depend on oscillation amplitude. Quadratic fields are well explored in TOF art. See Makarov et.al. in Int J. of Mass Spectrom and Ion Processes, v.146/147, 1995, pp.165-182. Unfortunately, such analyzers also introduce a large beam divergence. The inventor also realized that low energy TOF could be improved by introducing a radio frequency confinement of ion beam in at-least one direction. RF confinement eliminates ion beam divergence and also eliminates surface charging, crucial for low energy apparatuses. A novel type of TOF has been found, combining RF confinement with axial DC quadratic potential.

In-line TOF

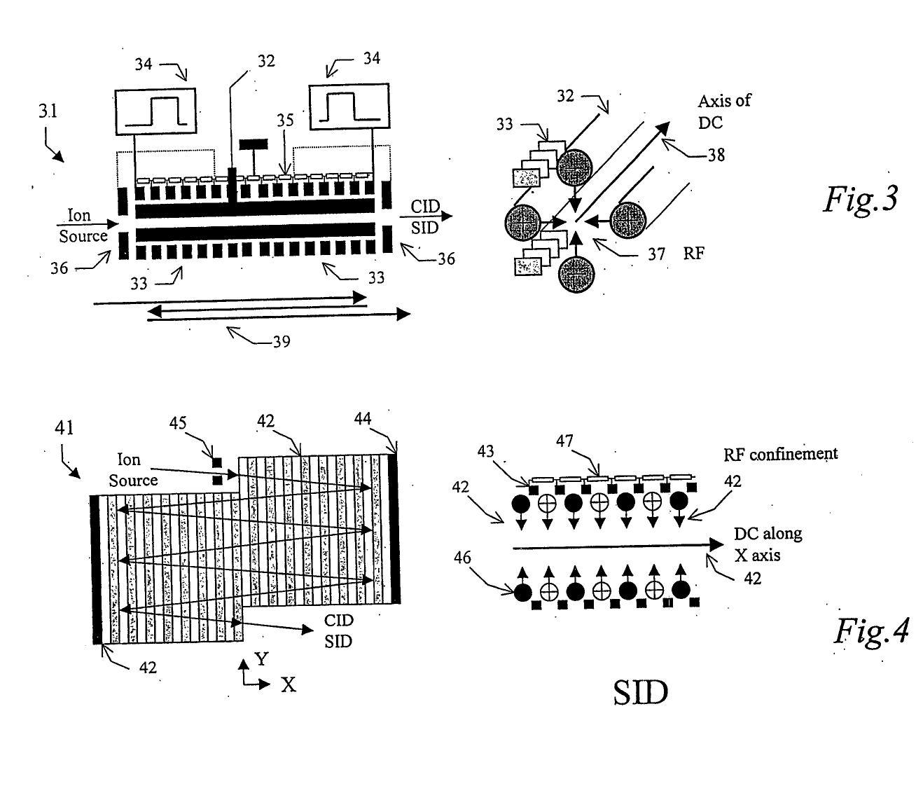

Referring to FIG. 3, the preferred embodiment of novel low energy time-of-flight separator (31) comprises an RF-only multipole (32), two electrostatic mirrors (33) and pulse generators (34). Mirrors are constructed of multiple electrodes, interconnected with a chain of dividing resistors (35). External electrodes of mirrors (33) are connected to pulse generators (34) and middle electrode of mirrors (33) being ground. End field is terminated by apertures (36), with potential adjusted as a portion of full potential on pulse generators (34).

In operation, RF field provides radial confinement, shown by arrows (37) on FIG. 3. Radial RF confinement does not affect ion motion along the axis. Axial parabolic electric field is formed by field penetration between multipole rods. Parabolic field provides ion axial reflections with period, grossly independent on ion energy and proportional to square root of ion m/z. Pulsing potentials on mirror ends allows switching between ion injection into TOF1, ion reflections (39) within TOF1 and subsequent ion release on the other end of TOF1. The effective flight path LEFF is N□+1 times higher than TOF1 length L, where N is a number of full turns. Overall, RF confinement and multiple reflections allow prolonged time separation without ion losses, while quadratic potential enhances TOF1 resolution and allows separation of a slow ion beam with a high relative energy spread.

The ideal quadratic scheme is altered by presence of free flight segment on the way in and the way out of TOF1. According to above cited publication by Makarov et.al, even in case of substantial field free flight, here c.a. 30% of LEFF, a mass resolution of 2000 is achievable for ion pulses with relative energy spread up to 50%. To keep free flight path below 0.3 LEFF, the scheme requires at least 5 reflections, corresponding to 2 full turns. It helps to increase Leff to 7.3 L but reduces mass range of parent ions to a factor of two, i.e. MMAX/MMIN<2.

W-TOF

Referring to FIG. 4, another preferred embodiment of novel low energy time-of-flight separator (41) comprises an RF channel (42), surrounded by a set of electrostatic electrodes (43), terminating electrodes (44), and a deflector (45). The RF channel is formed by multiple rods (46) with alternating RF phase and aligned along Y axis. Electrodes of electrostatic mirrors (43), are also aligned along Y axis, and are connected via a chain of dividing resistors (47).

In operation, rods (46) with alternating RF potential form an RF tunnel, confining ions in Z direction. Potential on electrodes (43, 44) is distributed by resistor chain to form quadratic potential along X axis with minimum at the center plane of TOF. Field of external DC electrodes penetrates into the RF channel, providing a weaker but still quadratic potential distribution. Not accounting fringing fields there is no field in Y direction. Ions are injected at a small angle to X axis and are deflected by deflection plates (45) to double deflection angle for ions with mean energy. The deflection reduces Y-spatial spread, caused by X-energy spread. Ion motion is combined of a slow drift along Y direction and of multiple reflections along X direction. Overall, ion trajectories have a wave shape, ending at the boundary of the RF tunnel. Ions gain some spatial spread at the exit of TOF, which partially compensated by ion post-acceleration and focusing by a lens.

According to SIMION simulations by inventor, even at 50% energy spread the 50×30 cm device allows N=4 to 5 pairs of reflections without mixing ions with adjacent turns. The effective flight path of the device equals to L*□*N, and reaches LEFF=7.5 m. The RF field does not limit TOF1 resolution up to R=1000. Obviously a second type of TOF1, which may be called RF confined W-shape TOF, provides a simpler operation and longer flight path in TOF1, thus improving separation in TOF1, mostly limited by ratio of flight time between two TOF analyzers. The complexity of TOF1 could be reduced by using printed circuit board (PCB) assembly.

Answering Objections

In both novel TOF mass separators, the period of each reflection is grossly independent on ion energy and is proportional to square root of ion m/z. Ions are confined by RF field and ion losses practically eliminated. Introduction of novel low-energy TOF analyzers makes the present invention practical, resolving the above mentioned objections:
1. High relative energy spread is compensated by quadratic distribution of potential in the ion mirror, created by DC electric field penetration into multipole guide or tunnel;
2. Because of TOF1 ability to operate at high relative energy spread, it can operate at much lower ion energy and at a much longer time scale, compared to conventional TOF. As a result, the apparatus tolerates a much longer ion pulse out of the ion source, and turn around time is no longer an obstacle;
3. Drastic difference in time scales of TOF1 and TOF2 allows time-nested data acquisition;
4. Ion losses are practically avoided by guiding ions within radio-frequency guide or tunnel;
5. Ion confinement by RF field and ion post-acceleration in-front of the CID cell allow full transmission of ion beam into the CID cell;
6. Time spread in the CID cell is reduced by using a short, high pressure cell with an additional axial DC field, and
7. Transient recorder with a large and fast averaging memory is recently introduced by Switzerland company Acquiris (www.acquiris.com).

The detailed description continues on the level of individual components: pulsed ion sources, fragmentation cell and TOF2, specifically tailored for purposes of the method and apparatus of the invention. Particular attention will be paid to the issue of time spread.

Vacuum MALDI Source

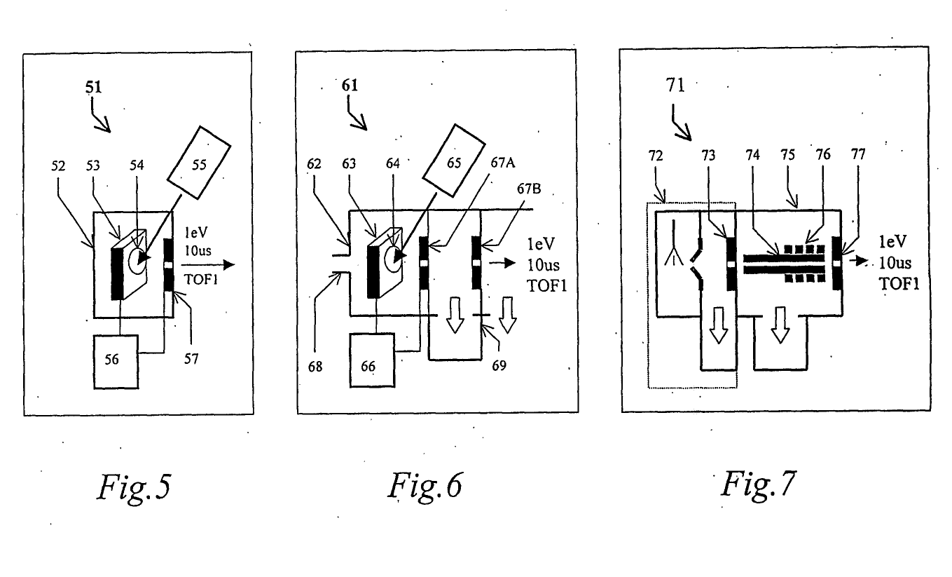

Referring to FIG. 5, TOF-TOF method and apparatus of the invention employ a pulsed MALDI ions source (51), comprising a source housing (52), a sample plate (53) with analyzed sample (54), a pulsed laser (55), a low voltage power supply (54), and an exit aperture (56).

In operation,, samples for analysis are prepared within matrices known in the art, and deposited on the sample plate (53). Pulsed laser (55) illuminates the sample and generates a short pulse of analyte ions. Ions are known to be ejected with 300 to 600 m/s velocity, which corresponds to initial ion energy between 0.5 and 1.5 eV for 1 kD. ion. Ions are accelerated by few Votls potential bias. One can estimate, that 1 kD ions leave ion source with few microseconds time spread and less than 1 eV energy spread. The major drawback of vacuum MALDI ion source is ion temporal instability, well described in conventional, high energy MALDI. The invention is likely to be applicable to softer MALDI ion sources, employing soft matrices or an infra-red laser. Temporal stability of ions is improved by collisional cooling, described below.

[Gas Filled Pulsed MALDI]

Referring to FIG. 6, TOF-TOF method and apparatus of the invention employs gas-filled pulsed MALDI ion source (61). The source (61) comprises features of vacuum MALDI source, such as a source housing (62), a sample plate (63) with analyzed sample (64), a pulsed laser (65), a low voltage power supply (66), and an aperture (67A); The source (61) also comprises a gas inlet (68), feeding gas into the housing (62), an additional pumping stage (69), terminated by exit aperture (67B) to reduce a gas load on TOF1 pump.

In operation, the source housing (62) is filled with buffer gas via the gas inlet (67). Gas pressure in the source housing is sustained between 0.01 to 1 Torr to provide ion collisional cooling (see Verentchikov et al, ASMS Conference 1999 in www.asms.org). Differential pumping system with two 1 mm apertures (67A, B) and two conventional 2501/s turbo pumps (one pumping TOF1), sustains vacuum in TOF1 better than 1 E-6 torr. The laser pulse generates a rapid (1 to 3 ns) ion ejection out of sample. The laser (65) is a high-energy laser to enhance ion production. Collisions with buffer gas relax ion internal energy. Collisions with gas also dampen ion kinetic energy to nearly thermal energy −0.01 to 0.1 eV, still retaining pulse property of ion beam. Ions are sampled by gas flow through the aperture, assisted by c.a 1V DC bias on the sample plate. Ions are then accelerated to kinetic energy, controlled by DC bias between apertures (67A, B), and leave the ion source. Internally cold ions are stable and survive long separation in TOF1 without ion decomposition. Overall, gas dampening in the MALDI source benefits TOF-TOF method of present invention, while leaving time and energy spread within boundaries 10 us and 1 eV, feasible for slow TOF1 separation.

Continuous Ion Source

Referring to FIG. 7, the TOF-TOF method and apparatus of the invention employ a pulsed ion source (71), comprising a continuous ion source with soft ionization (72) with an exit aperture (73), and a gas filled RF trapping device (74), enclosed in an additional pumping stage (75). Continuous ion source is of the following list: electrospray (ESI), APCI, gas filled MALDI, PI or CI. The trapping device is of the following list: 3-D Paul trap, linear RF only multipole with axial ejection, curved RF multipole with radial ejection. The preference is given to linear quadrupole ion trap with axial ejection. The quadrupole (74) is surrounded by DC electrodes (76) and apertures (73, 77).

In operation, the quadrupole is filled with buffer gas at 1 to 100 mTorr pressure. Differential pumping system (75) reduces gas load on TOF1 pumping. Ions are generated in the ion source (72) and continuously fill the RF-only quadrupole ion guide (74). Gas collisions dampen ion kinetic energy and confine ions at quadrupole axis and at the bottom of DC well created by electrodes (76) and aperture (77). Periodically, potential on electrodes (76) and exit aperture (77) are adjusted to eject stored ions in axial direction into TOF1. One can estimate that ion pulse has less than 1 eV energy spread and less than 10 us time spread.

In all above examples, pulsed ion sources are capable of generating ion pulse with less than 1 eV energy spread and less than 10 us time spread. A desired TOF1 mass resolution of 300 to 500, sufficient to separate a group of isotopes, requires 600 to 1000 time resolution. Because of 10 us initial time spread, the flight time for 1 kD ions has to be at least 10 ms, achievable at few electron-Volts ion energy and effective flight path from 5 to 10 m. The above described multi-turn TOF1 analyzers provide 10 m effective path within a 0.5 to 1 m device. The next logical question is whether ions could be fragmented within 10 us, so that primary separation would not be ruined.

Cid Cell

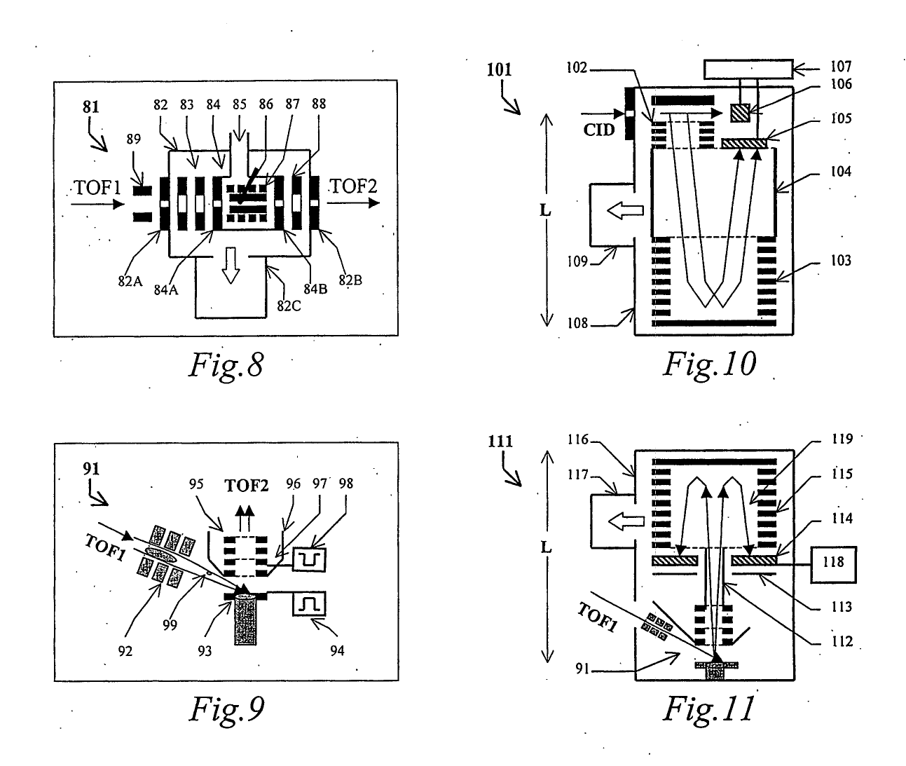

Referring to FIG. 8, the TOF-TOF method employs a short, high gas pressure CID cell (81) for ion fragmentation. The CID cell (81) comprises a vacuum housing (82), an entrance lens (83), a CID chamber (84) connected to gas inlet (85), an RF focusing device (86) with optional DC electrodes (87), enclosed in the CID chamber, and exit ion lens (88). The CID cell also comprises an optional timed ion selection gate (89). The gas inlet feeds buffer gas into CID chamber. The CID chamber (83) comprises apertures (83A, B). The vacuum housing (82) comprises apertures (82A, B), and vacuum pump (82C). The RF focusing device is preferably a RF-only quadrupole.

Conventional CID cells, typically 10 to 20 cm long, operate at c.a 10 mTorr gas pressure. In order to provide rapid ion transfer, the CID cell, employed in the present invention, is much shorter, typically 5 to 10 mm, and operates at much higher gas pressure, above 300 mTorr. High pressure region is concentrated in the chamber 84 and is surrounded by additional layer of differential pumping. Apertures 84A, B, typically 1.5 mm diameter, limit total gas flow into vacuum housing to c.a 0.1 Torr*L/s. Pump 82C with pumping speed of 300 L/s evacuates vacuum housing to c.a 3 E-4 Torr. Apertures 82A, B, typically 1.5 mm diameter, further reduce gas flow into TOF1 and TOF2, operating at gas pressure below 3 E-7 Torr. To avoid gas discharge, the RF amplitude is reduced below 300V, accompanied by frequency drop below 1 MHz.

In operation, ions are accelerated in-front of the cell to energy sufficient for ion fragmentation, typically 50 eV/kDa. Ion packets enter the cell via apertures 82A and 84A, being focused by lens 83. At 300 mTorr gas pressure, gas density equals n=1E+22m−3, and an ion of 1 kD mass with a cross section of □=100 A has a mean free path □=1/n□=0.1 mm. For typical quadrupole length of L=1 cm, ion experience c.a. 100 collisions. Number of collisions, 3 times higher than ion/gas mass ratio, is sufficient to ensure fragmentation with subsequent dampening. First energetic collisions convert ion kinetic energy into ion heating, causing ion fragmentation. Once ions loose kinetic energy, subsequent gas collisions stabilize fragment ions, further dampens their kinetic energy and confine ions to axis due to RF field focusing. The phenomenon of collision dampening in CID cell is well described in U.S. Pat. No. ______ by Don Douglas.

Time spread of ion beam in CID cell is of primary concern in the present invention. Travel time before high pressure region is assumed while tuning TOF1, and it creates time delay only, not time spread. Gas collisions can cause significant time spread even in a short CID cell. To reduce the spread, ion passage through the cell is assisted by electrostatic axial field, created by DC potentials of apertures 84A, B. At typical quadrupole inscribed diameter D=1 cm and length L=1 cm, fringing fields penetrate into RF quadrupole, being suppressed by factor, less than 2. Accelerating potential of 20V can provide ion drag through gas at velocity c.a. 500 m/s, limiting full passage time below 20 us and time spread below 10 us. Controlling passage time helps to bunch ions (i.e. compress duration of ion pulse) prior to injection into TOF2. The accelerating field in CID cell is modulated, being synchronized (with time shift) to TOF2 injection pulses.

SID Cell

Referring to FIG. 9, the TOF-TOF method and apparatus of the invention employ a fragmentation cell (91) with surface induced dissociation (SID) for ion fragmentation. The SID cell (91) comprises a bunching (temporal focusing), spatial focusing and steering lens (92), a probe (93), coated with fluorocarbon mono-layer, a pulse generator (94), attached to the probe, a DC accelerating column (95), surrounded by ground shield (96). The DC accelerating column comprises a mesh (97), connected to a pulse generator (98).

In operation, ion packet of time separated parent ions is pulse accelerated to c.a. 50 eV/kDa specific energy, being bunched by a lens (92). Bunching, previously employed in magnet sector-TOF tandems, is known to compress ion packet duration below dT<1 us. The lens (92) focuses and steers parent ion packet (99) onto the center of the probe (93). Ion beam impinges the surface at some angle, say 45 degree. Medium energy collisions with fluorocarbon mono-layer surface are known to induce fragmentation of peptides and small molecular ions. Fragment ions bounce off the surface with c.a. 500 to 2000 m/s velocity, travelling less than 2 mm within dT<1 us of primary ion packet duration. During impinging a small retarding potential is applied to the mesh 97, preventing leakage of fragment ions into the TOF2 analyzer. After an appropriate delay, corresponding to impinging of the entire primary ion packet, pulse generators 94 and 98 are triggered, and electric pulses are applied to the probe 93 and the mesh 97. Fragment ions are pulse accelerated into the TOF2 analyzer.

Compared to the CID cell, the SID cell has advantages of:
1. operating at low pressure and thus reducing requirements on pumping system
2. removing time spread in fragmentation step
3. accepting wider beam of primary ions.
4. Disadvantages of SID are
5. poorly characterized fragmentation pattern of medium mass ions
6. higher energy spread of fragment ions, reducing TOF2 resolution
7. metastable decay of fragment ions in TOF2 analyzer.
   The CID cell is better suited for in-line TOF1, while SID cell is better suited for W-TOF1.

Referring to FIG. 10, the TOF-TOF method and apparatus of the invention employ a conventional orthogonal TOF (101) for mass analysis of fragment ions, preferably in conjunction with the CID cell. The o-TOF (101) comprises orthogonal pulse acceleration (102), an ion mirror (103), a floated free-flight region (104), a TOF detector (105) and an in-line detector (106). Both detectors are connected to a data acquisition system, comprising fast averaging transient recorder (107). TOF analyzer (101) is enclosed into vacuum chamber (108) and is evacuated by a pump (109).

Operation of o-TOF is well described in the art. Continuous or pulsed ion beam, accelerated to c.a 10 eV, enters acceleration region. Periodic pulses accelerate ions orthogonal to c.a. 3 keV and inject ions into the TOF analyzer. Ions get reflected in the ion mirror and hit the TOF detector 105. A portion of initial ion beam is acquired on the in-line detector 106. To accommodate rapid analysis of fragment ions, parameters of the o-TOF are slightly altered. The analyzer is small—L=10 to 20 cm, operates at high TOF energy (5 to 15 kV) to accommodate high repetition rate, c.a. 100 KHz. Small size analyzer allows operation at gas pressure slightly below 1 E-5 Torr. The conventional TOF analyzer is also modified by using high current secondary electron multiplier (SEM) or hybrid MCP/PEM for detector and by using a fast averaging transient recorder for data acquisition system. Small length and short flight time pose limit on TOF2 resolution. To improve resolution of TOF2, one can increase flight time in TOF2, while limiting time windows of admitted ions by either of:
1. 10 us time gate interleaved between IMS scans and use slower pulse rate of TOF2;
2. pulse TOF2 at 100 KHz rate and divert ions within TOF2 onto several detectors;
3. pulse TOF2 at 100 KHz rate and use position sensitive detector in TOF2.

TOF2 is optionally equipped with in-line detector in order to avoid acquiring signal in blank time, when no ions are coming from TOF1.

Conventional TOF2

Referring to FIG. 11, the TOF-TOF method also employs a conventional reflecting TOF (111) for mass analysis of fragment ions, preferably in conjunction with the SID cell. The TOF (111) comprises a built-in SID cell (91), an electrically floated free flight region (112), a detector (114) with a detector shield (113), an ion mirror (115), a vacuum housing (116), a pump (117) and a transient recorder (118) for data acquisition.

In operation, a pulse of fragment ions is accelerated within the SID cell 91, fly through the field free region 112, get reflected in the ion mirror 115 and hit the detector 114. Ion trajectories are shown by lines 119. Signal from the detector is acquired on the transient recorder 118. Again, for the purposes of rapid data acquisition the analyzer is short, L=10 to 20 cm, operates at high acceleration potential to accommodate high repetition rate of 100 KHz.

Having described individual components, it become easier to grasp the concept and peculiarities of the integrated TOF-TOF method and apparatus. Below find specific examples of TOF-TOF tandems of the invention, though, not limiting a multiplicity of viable combinations.

MS-MS with In-Line TOF-CID-o-TOF

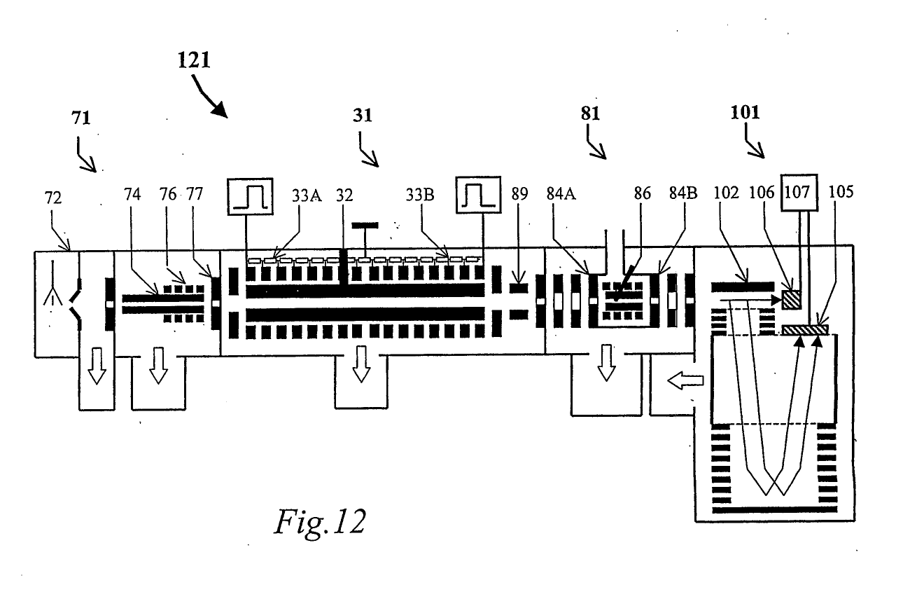

Referring to FIG. 12, one preferred embodiment of TOF-TOF instrument (121) comprises sequentially connected pulsed source (71) with continuous ion source (72), the storage quadrupole (74) and electrodes (76,77), the in-line time-of-flight mass spectrometer TOF1 (31) with the RF-only quadrupole guide (32), surrounded by two pulsed ion mirrors (33A,B), the short gas-filled collision CID cell (81) with RF quadrupole (86), surrounded by apertures (84A,B) and the second, orthogonal time-of-flight mass spectrometer o-TOF2 (101) with the pulse accelerator (102), equipped with analog data acquiring system (107). Individual components have been described above and are shown on FIGS. 3, 7, 8 and 10, and their previous numbers are retained in further discussion.

In operation, continuous ion source 71 feeds parent ions into the storage quadrupole 74. Once in every 10 to 20 ms ions are ejected out of storage quadrupole, by pulsing potentials of DC electrodes 76 and of exit aperture 77. Ejected ion packet, containing multiplicity of various parent ions is less then 10 us long and has less than 1 eV energy spread. Mean energy of ejected ion pulse is adjusted to c.a. 2 eV by selecting pulse potentials of electrodes 76 and 77. Ions are admitted into the TOF1 separator by dropping potential of the first mirror 33A. Ions are radial trapped by quadrupole RF field, but are free to travel along the quadrupole axis. Once parent ions of all masses (limited to the ratio Mmax/Mmin=2) pass the first mirror, the first mirror 33A is turned on. The second mirror 33B has been turned on within a previous cycle. Ions experience multiple reflections, preferably 5 reflections, between two mirrors with quadratic potential distribution along the TOF1 axis. Period of oscillation is grossly independent on ion energy and is proportional to square root of parent ion mass. The effective flight path of analyzer is up to 2□+1=7.3 times longer than the physical length of TOF1. After preferably 5 reflections ions are released out of the TOF1 by lowering-potential of the second mirror 33B. The train of time separated ion packets enters the CID cell. Typical time scale of time separation is of 10 ms, measured as a flight time of 1 kDa ions, and duration of each packet, corresponding to parent ion mass, is approximately 10 us. Parent ions are separated with c.a 1000 time resolution, corresponding to 500 mass resolution.

After leaving TOF1, each ion packet is accelerated to a specific energy of 50 eV/kDa, sufficient to induce fragmentation in gas collisions. Ions are focused by lens system and injected into high pressure CID cell via aperture 82A and 84A. Ions fragment in the cell, and fragment ions are collision dampened and confined by RF field. The cell is actively emptied by pulsed potential of two CID apertures 84A, B, synchronous and time shifted relative to TOF2 pulses. Ions enter orthogonal acceleration region 102, get injected into TOF2 analyzer, being time separated and, thus, mass analyzed in TOF2. Synchronized injection into TOF2 eliminates time gaps, i.e. almost no fragments are lost between TOF2 pulses. Synchronous injection also improves duty cycle of TOF2. Most of fragment ions are contained within acceleration region 102 at the time of TOF2 pulse.

TOF2 spectra present fragment spectra for every time separated parent ion mass. Spectra with the same TOF1 tag (i.e corresponding to parent ions of the same m/z) are summed over multiple source injections. Within 1 second acquisition the data will contain 1000 fragment spectra, averaged over 100 source injections.

In the above described apparatus there are three almost equal (c.a.10 us) sources of time spread, deteriorating resolution of TOF1 separation: time spread gained in the ion source; time spread in the CID cell and due to TOF2 digitization (i.e. acquiring spectra at discrete time). Assuming no correlation between those three sources, the overall time spread is estimated as 17 us (square root of three higher than each spread). The resulting resolution of TOF1 separation becomes equal to 300, which is still considered to be a fair resolution for parent ion separation. For comparison, TOF1 resolution in commercial MALDI TOF-TOF is c.a 100, and quadrupole resolution in Q-TOF in a high sensitive mode is c.a 300. Resolution of TOF1 of the present invention can be potentially improved by one of the following means:
Increasing length of TOF1 above 1 m;
Optimizing ion energy within TOF1;
Applying timed gate with multiple narrow mass windows, interleaved between scans;
Pulsing TOF2 faster and diverting ions onto several detectors;
Using position sensitive detector in TOF2.

MS-MS with W-TOF-SID-coax TOF

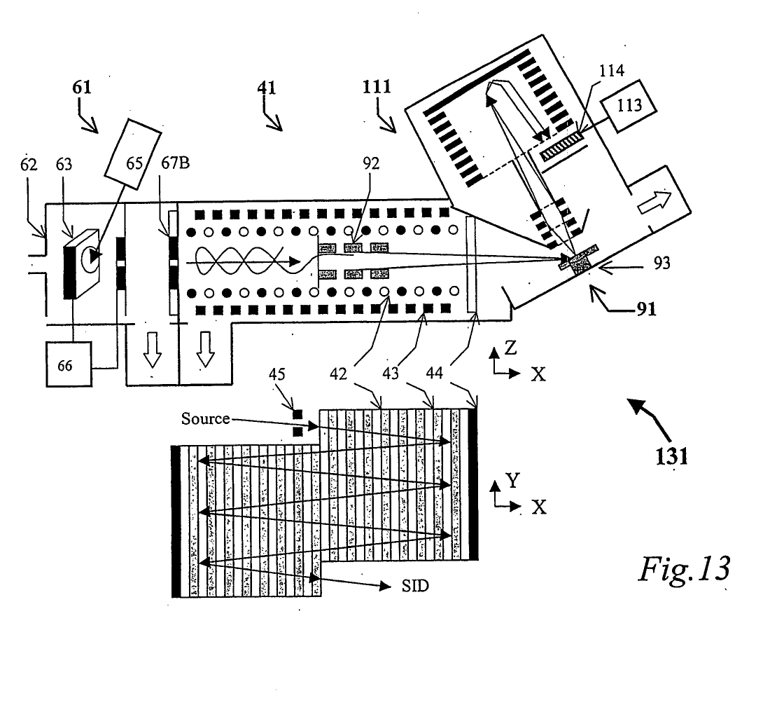

Referring to FIG. 13, another preferred embodiment of TOF-TOF apparatus of the invention comprises the gas-filled pulsed MALDI ion source (61), the novel W-shape TOF1 (41), the SID cell (91) and the coaxial TOF2 (111). The source 61 comprises, a gas-filled chamber (62), a sample plate (63), a laser (65) and a low voltage bias supply (66), connected to the sample plate 63. The TOF1 41 comprises deflection plates (45), two static reflectors (43) with terminating plates (44), and a two-dimensional RF tunnel (42). Static reflectors (43) surround the RF channel 42 to form a quadratic potential distribution. The SID cell 91 comprises a bunching and focusing lens (92) and a probe (93), coated with fluorocarbon mono-layer. The TOF1 111 comprises a secondary electron multiplier-SEM (113), connected to a transient recorder (114). The source 61 and the SID cell 91 are located off-line to allow multiple ion reflections within TOF1 41. The above selected combination of elements is chosen mostly to demonstrate interaction between elements, not described in the previous TOF-TOF embodiment.

In operation, laser 65 pulses produce a short burst of primary ions off the sample plate 63 at a repetition rate of 50 to 100 Hz. The source chamber 62 is filled with gas to relax ion internal energy and prevent ion decomposition. Ions are sampled through a thin gas layer by electric field and gas flow, so that ion packet remains shorter than 10 us and has energy spread less than 1 eV. Ion packet is accelerated by another few Volts potential by low voltage bias supply 66 and get injected into the multi-reflecting, TOF1 41 at a small angle to the Y axis. The steering plates 45 double the angle to reduce spatial spread in X direction, related to Y axis energy spread. Ion motion within TOF1 has three independent components—oscillation in confining RF field in Z-direction, multiple reflections along Y axis with period almost independent on ion energy, and slow drift along orthogonal—X axis. After several Y bounces ions leave TOF1 and enter the bunching lens 92 of the SID cell 91, being time separated into a train of ion packets, aligned according to their m/z ratio. Multiple reflections at small ion energy allow prolonged time separation in the order of 10 ms. Since quadratic DC field in TOF1 compensates for ion energy spread, separation in TOF1 does not increase the said 10 us time spread of ion packets. Thus, after leaving TOF1 parent ions are separated with c.a. 300 to 500 mass resolution.

Periodically, say once in every 10 us, ions are time bunched into c.a 1 us packet and spatially focused to c.a 1 mm by a pulsed lens 92. Pulse focused ion packets hit the surface of the SID probe 93, coated with fluorocarbon mono-layer. Collisions with surface induce ion fragmentation. Fragments, slowly moving from the surface, are spread for c.a 1 mm within 1 us time. A delayed electric pulse, applied to the probe 93, accelerates fragment ions and injects them into the second TOF2 111 analyzer. Initial parameters (i.e. parameters prior to the probe pulse) of fragment ions are good enough to carry mass analysis in TOF2 with resolution of couple thousand. Signal is detected on the SEM 114 with high dynamic range. Signal is passed to the transient recorder 113, and data are acquired in a time-nested fashion. TOF2 transients, representing fragment spectra of various parent ions, are not mixed together. Each fragment mass spectrum obtains time tag of TOF1 separation, measured as a time between source pulse and bunching lens pulse. TOF1 time tags carry information on parent ion m/z ratio. TOF2 spectra with the same TOF1 time tag are averaged over multiple laser pulses to improve signal to noise ratio.

The inventor stresses the point that comprehensive TOF-TOF method of the invention could be realized employing simpler static TOF1. Below find several examples of static separators. Retention of ion beam is static field requires operation at relatively higher energy around 100 eV. Millisecond separation time is achieved by extending flight path and using focusing properties of specially designed electrostatic fields.

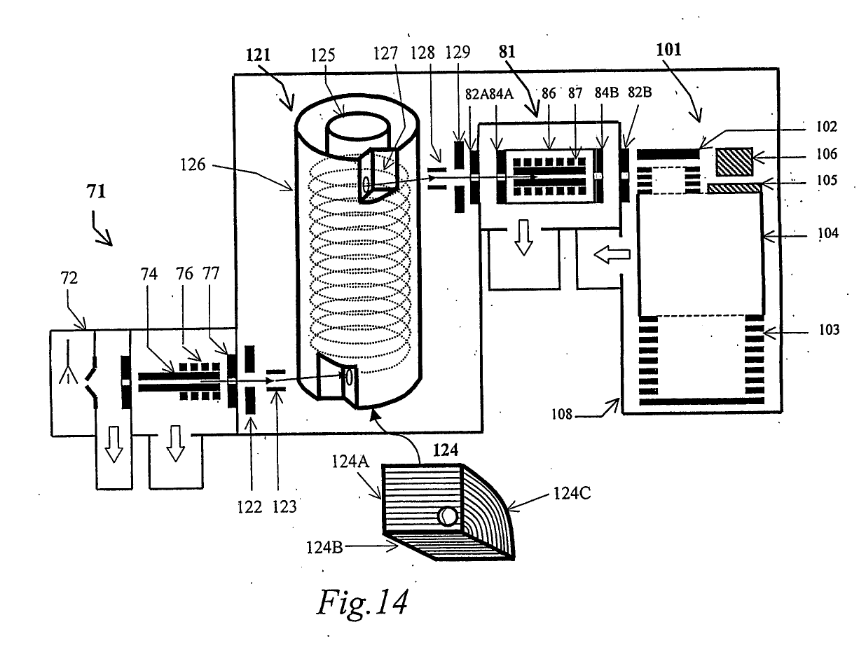

Referring to FIG. 14, another preferred embodiment of low energy time-of-flight separator (121) comprises an electrostatic lens (122), a deflector (123) and analyzer, consisting of entrance unit (124), two coaxial electrodes (125) and (126) with DC voltage applied between them, and exit unit (127), followed by deflector (128) and lens (129). The described device is known as spiratron and is described in: Bakker I. M. B., The Spiratron. In: Adv. In Mass Spectrom., London, 1971, v.5, pp. 278-280. The novelty is introduced by using the device as a low energy separator in tandem TOF system.

In operation, ion beam from a pulsed ion source (71) is transformed by lens (122) into a much wider beam with proportionally lower angular spread (a “quasi-parallel beam”). This beam is deflected by deflector (123) to provide a controlled angle of inclination a to the axis of electrodes (125) and (126). It should be obvious to anybody skilled in the art that the same effect could be achieved for example, by positioning electrodes (125) and (126) at a fixed angle. The ion beam enters electrostatic radial field between electrodes (125) and (126) via an aperture in the entrance unit (124). One preferred embodiment of the entrance unit (124) consists of 3 double-sided printed-circuit boards (PCB). Outside surfaces of these boards face deflector (123) and have metallization on them to create an equipotential surface. Inner surfaces of these boards face the gap between electrodes (125) and (126) and contain a set of metallization strips. These strips are connected to a resistive voltage divider that provides a voltage distribution matching the ideal logarithmic voltage distribution between electrodes (125) and (126) and thus minimizing perturbation of this field along ion trajectories. Exit unit (127) may have similar construction.

After ions pass through entrance unit (124), they start moving along a spiral trajectory, wound around electrode (125), and separate in time-of-flight according to their mass-to-charge ratios. To minimize ion beam size, this spiral needs to be circular. This is achieved when voltage U between electrodes (125) and (126) corresponds to mean ion energy V1 as

$$U = 2 {V}_{1} ln ( \frac{{r}_{2}}{{r}_{1}} ) ,$$

where r1 and r2 are radii of electrodes (125) and (126) correspondingly. After a number of rotations, ions exit the field through the exit unit (127), after having drifted distance H along the axis. Construction of the exit unit (127) is similar to that of the injection unit (124). The maximum number of rotations is limited mainly by full angular spread ^{Δα} of the ion beam (^{Δα}<<1) that in its turn is limited by effective temperature of the initial ion beam kT:

$$Δα \approx \frac{p}{M} \sqrt{\frac{kT}{{V}_{1}}} ,$$

where M is magnification of lens (122) and coefficient p depends on the required confidence level (p≈4 for 95% of ions, p≈5 for 99% of ions, and p≈6.6 for 99.9% of ions). In the present example we choose M=5 and p=5, which will limit ^{Δα} to 1/45, i.e. approximately 1 degree. Then the maximum total length of trajectory is

$${L}_{1} \approx \frac{H}{Δα \cdot cos ( α )} \approx \frac{H \cdot M}{p} \sqrt{\frac{{V}_{1}}{kT}}$$

For example, for length H=0.5 m, kT=0.05 eV, V1=100 V, M=5, then total flight path is L1∓22 m. Let us define ratio of time scales between TOF1 and TOF2 as:

$$Ratio = \frac{1}{2} \cdot \frac{TOF1}{TOF2} = \frac{1}{2} \cdot \frac{{L}_{1}}{{L}_{2}} \sqrt{\frac{{V}_{2}}{{V}_{1}}}$$

This value defines the limit on the maximum mass resolving power of TOF1 caused by the pulsed nature of TOF2. For the parameters above, effective path length of TOF2 L2=0.5 m and mean acceleration voltage V2=5000 V, Ratio≈150, which corresponds to mass resolution of TOF1 separation R˜75. Since resolution is also limited by relative energy spread of ion beam to c.a. R=100 it is not worth using longer device. Though resolution is inferior, compared to above described TOF1 spectrometers, the spiratron device has an advantage of simplicity, higher operation energy and it works without stroboscopic techniques prior to TOF2. Resolution of 75 is still useful in separating complex mixture of primary ions. For comparison separation in PSD MALDI has resolution from 50 to 100, and separation in typical triple quadrupole experiments is typically around 300.

Mean radius of the spiral r0 could be chosen on the basis of practical constraints, mainly the period d of metallization strips on boards 124A-124C, For example, for r0=80 mm, step of the spiral is 15 mm. If d=3 mm, the resulting gap between the beam and plate (124C) ensures sufficient attenuation of fringing fields even for initial beam size 3-4 mm after lens (122) (for M=5, this corresponds to ion beam diameter of 0.6-0.8 mm on the exit from the source (71)).

The novel static low energy TOF can be coupled to any of above described fragmentation means and TOF2 spectrometers or fragment analysis. Referring to FIG. 14 the TOF1 121 is coupled to the CID cell 81 and the orthogonal TOF 101. The major challenge in this combination is to focus the primary beam onto the entrance of the CID cell. Though ion beam has high 100 eV energy and beam gets wider at the exit, the beam is grossly parallel and can be well focused onto small aperture by conventional lens.

Multi-Pass TOF1

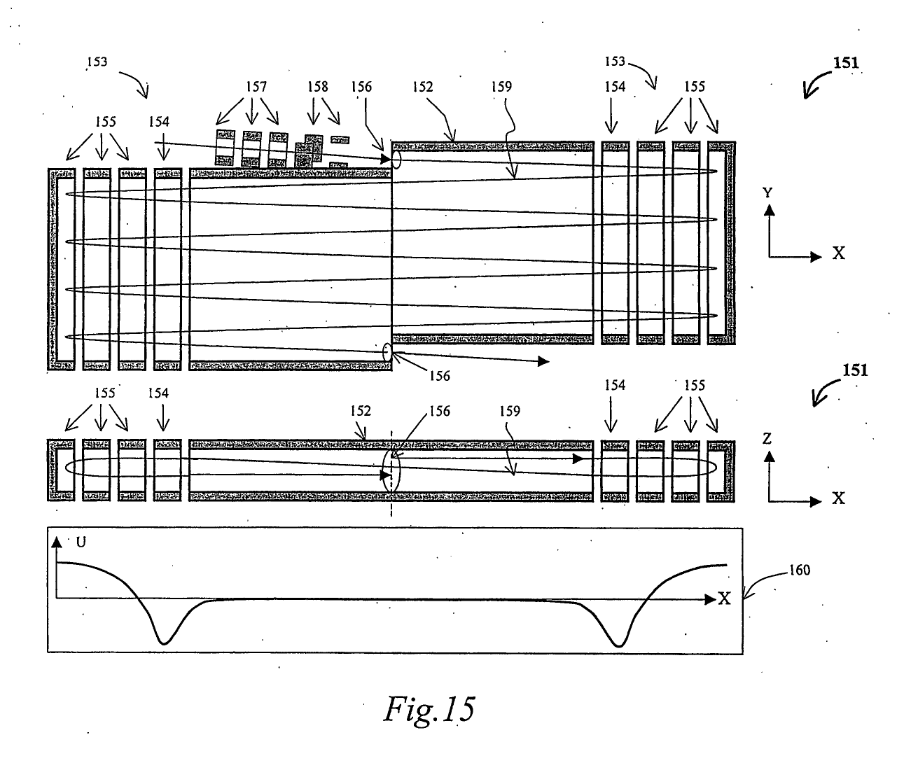

Referring to FIG. 15, another preferred embodiment of the first (i.e. TOF1) time of-flight separator of the invention (151), further called ‘electrostatic multi-pass separator’, comprises a free flight channel (152), and two electrostatic mirrors (153), composed of focusing electrodes (154), and reflector electrodes (155). The free flight channel 152 has entrance and exit windows (156). All electrodes are extended along Y axis such that electrostatic field is two-dimensional in the area of ion path. Pulsed ion beam is introduced into the multi-turn electrostatic TOF 151 via spatial focusing lens (157) and a set of steering plates (158). Ion path of ions is shown by the line (159). Typical axial potential distribution U(x) is shown by the graph 160.

In operation, ion pulse is focused into a parallel beam by lens 158 and is steered by plates (159). The beam is introduced into the separator 151 via the entrance window 156 at a small angle to X axis. Ions experience multiple reflections along X axis, while slowly drifting along Y axis. After multiple full turns (each full turn is formed by pair of reflections) ions leave separator through the exit window 157, being time separated according to their m/z ratio. Number of full turns depends on injection angle—both adjustable by potentials on steering plates.

Electrostatic mirrors are designed similar to mirror in griddles TOF, well known in the art. Electrostatic potentials, applied to mirror electrodes are tuned to satisfy conditions of spatial focusing and time-of-flight focusing. Graph 160 shows the type of axial potential distribution U(x), satisfying those requirements. To provide spatial focusing along Z direction, each of electrostatic mirrors 153 form a lens with focal point, located near the center plane of free flight region (shown by dashed line). Ion beam (line 159), starts as a parallel beam at the entrance window 156. After first reflection in the right side mirror the beam is focused into a point at the middle plane. Note, that focusing of all ions is presented on the drawing by single ion trajectory, intersecting the axis. After reflection in the left hand mirror, the beam is again converted into a parallel beam.

According to inventor's ion optics simulation using SIMION program, the spatial focusing in the specific TOF1 151 is compatible with time-of-flight focusing in at least first order, i.e. first derivatives of flight time on initial energy and on orthogonal displacement are equal to zero. Ion beam remains confined if only initial spatial spread is under 5% of TOF1 width and angular spread is below 2 degrees. For energy spread under 3% the time of flight resolution of TOF1 exceeds 10,000. Such initial conditions are realistic for ion beam accelerated to approximately 30 electron Volts after pulse ejection out of linear storing quadrupole.

Operation at relatively higher energy (30 to 100 eV), compared to other embodiments, requires longer ion path in TOF1 (30 to 100 m) to achieve millisecond time scale separation in TOF1. Ion path could be easily extended, because of low complexity of TOF1 design and its static operation. Instrument of 1 m long with approximately 20 full ion turns corresponds to at least 50 m effective flight path.

Cylindrical Multi-Pass TOF1

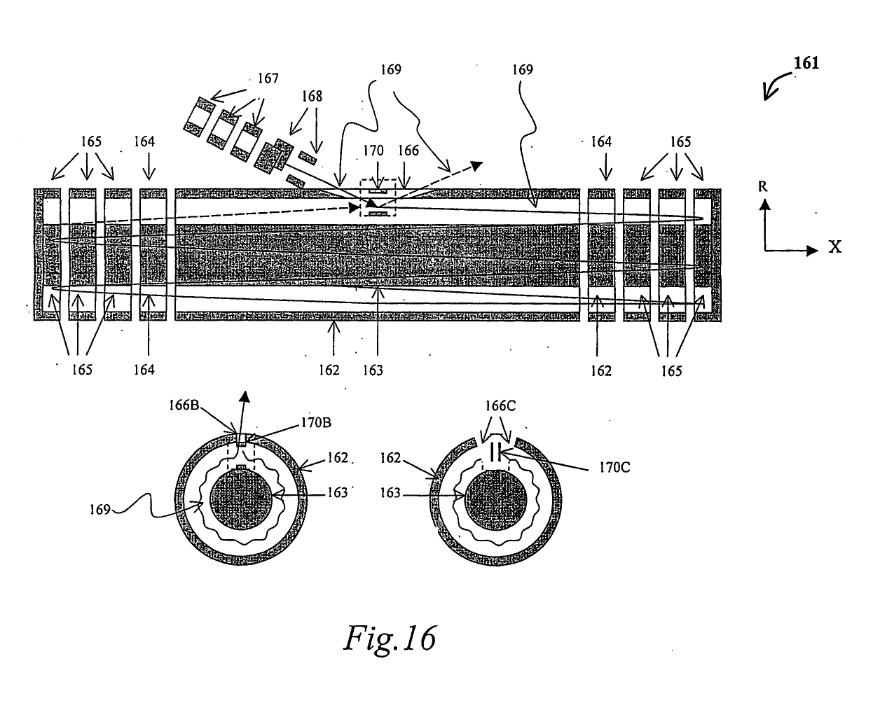

Referring to FIG. 16, another preferred embodiment of the invention presents modified electrostatic multi-pass separator, formed by folding two dimensional field into a cylindrical field. In this embodiment, called cylindrical multi-pass separator (161), for the purpose of compact design, each elongated electrode is converted into a pair of coaxial cylinders—internal and external. The separator 161 comprises a free flight channel, formed by cylinders (162,163), and two electrostatic mirrors, composed of focusing cylinders (164), and reflector cylinders (165). The external cylinder of free flight channel 162 has entrance and exit windows (166), equipped with beam deflector (170). Pulsed ion beam, is introduced into separator 161 via spatial focusing lens (167), via a set of steering plates (168), through entrance window 166 and deflector 170. Ion path is shown by the line (169).

In operation, the cylindrical separator is very similar to the above described two-dimensional electrostatic multi-pass separator. Ions are forced to make multiple bounces between mirrors, while being spatially focused by lens electrodes. In order to retain ions near same radius of orbit, an additional potential is applied between external and internal cylinders 162 and 163. Radial deflecting potential could be also applied between external and internal cylinders of electrodes 164 and 165.

Entrance and exit of ions can be organized in multiple ways. FIG. 16B shows an example of ion introduction through a slit-shaped window 166B with subsequent horizontal deflection, aligning ion beam along X-axis. To reduce fringing field, the deflector 170B is surrounded by mesh. FIG. 16C shows an example of ion introduction along X axis through a segment cut-out in the entire cylindrical analyzer. Beam is injected into analyzer after horizontal deflection by plates 170C. Field distortion is minimized by using double-sided PCB, equi-potential within cut-out and with distributed potentials on the side oriented towards cylindrical analyzer. The above described slow electrostatic multi-pass separators are suggested for use, in comprehensive tandem TOF spectrometer of the invention in variety of combinations with earlier described pulsed ion sources, fragmentation cell and fast second TOF.

Obviously, presented examples of TOF1 separators, including separators with RF confinement, spiratron and static multi-pass separators, do not exhaust all the possibilities of TOF1, providing prolonged time separation, while retaining ion beam, but rather prove feasibility of general method of comprehensive tandem TOF mass spectrometry of the invention.

Achieved Effect

The above described comprehensive tandem TOF spectrometers of the invention are gaining speed and sensitivity of analysis, compared to existing TOF-TOF mass spectrometers. The improvement is achieved by employing principle of time-nested acquisition, first time applied to tandem TOF. Ion pulses out of the ion source are fully utilized and multiple parent ions are analyzed per single source pulse. The invention also improves the rate of MS-MS information, compared to closest prototype—IMS-TOF, also employing time-nested acquisition. The improvement is made by getting much higher resolution at the step of parent ion separation and thus, providing analysis of more complex mixtures.

LC-LC-MS-MS

Much higher speed of tandem MS-MS analysis opens an opportunity of coupling multi-step liquid-phase separations with tandem MS analysis at realistic time scale. Such separation techniques may include affinity separation, liquid phase chromatography (LC) and capillary electrophoresis (CE). High speed LC and CE separation at few minutes time scale became routine in LC-MS analysis. However, LC-MS-MS analysis is usually slowed down by low speed of MS-MS stage, no longer the case after introducing the comprehensive TOF-TOF method and apparatus of the invention.

Having described preferred embodiments and some examples of combining useful elements; it will now become apparent for one skillful in the art that other embodiments incorporating the concepts may be used. It is felt, therefore, that these embodiments should not be limited to disclosed embodiments, but rather should be limited only by the spirit and the scope of the following claims. In claims, the ion mobility-orthogonal TOF is considered as the closest prototype.

1. A tandem mass spectrometer comprising sequentially connected pulsed ion source, a parent ion separator, a fragmentation cell, a second time-of-flight mass spectrometer (TOF2) and a time nested data acquisition system, acquiring fragment mass spectra for multiple parent ions, wherein to improve resolution of parent ion separation the said parent ion separator is a time-of-flight mass spectrometer and wherein, for ions of the same mass-to-charge ratio, time-of-flight in the said TOF1 is significantly larger than both passage time through the said fragmentation cell and time-of-light in the said TOF2.

2. A tandem mass spectrometer of claim 1, wherein time-of-flight in the said TOF1 is at least 10 times larger than time-of-flight in the said TOF2.

3. A tandem mass spectrometer of claim 1, wherein average ion energy in the said TOF1 is at least 100 times smaller than in the said TOF2.

4. The tandem mass spectrometer of claim 1, wherein the pulsed ion source is MALDI ion source with gas pressure from vacuum up to 0.1 mbar.

5. The tandem mass spectrometer of claim 1, wherein the pulsed ion source comprises a pulse operating radio frequency (RF) storage device and a continuous ion source of the following list: an Electrospray source, a MALDI ion source, filled with gas at gas pressure between 10 mtorr and 1 atm, an electron impact ion source, electron impact with chemical ionization ion source, or photo ionization ion source; ions are continuously supplies from any of said ion sources to become accumulated and pulse-ejected out of the said storage device.

6. The tandem mass spectrometer of claim 5, wherein said storage device comprises at least one RF-only linear multipole, supplemented by at least one DC electrode, creating non-zero axial electric field.

7. The tandem mass spectrometer of claim 1, wherein said TOF1 comprises RF only linear multipole, surrounded by two pulsed mirrors with axial quadratic electric field.

8. The tandem mass spectrometer of claim 1, wherein said TOF1 comprises two dimensional RF-only ion tunnel, surrounded by two-dimensional DC mirrors with quadratic electric field.

9. The tandem mass spectrometer of claim 1, wherein said TOF1 comprises at least a pair of coaxial electrodes with DC voltage applied between them and wherein ions are injected between said electrodes at an angle to their axis.

10. The tandem mass spectrometer of claim 9, wherein ions enter and exit the gap between said electrodes through a cut-off boundaries, which are formed by double sided printed circuit boards

11. The tandem mass spectrometer of claim 1, wherein said TOF1 is a planar multi-pass electrostatic TOF, comprising a two-dimensional free flight channel and two planar focusing electrostatic mirrors, composed of focusing and reflecting electrodes.

12. The tandem mass spectrometer of claim 1, wherein said TOF1 is a cylindrical multi-pass electrostatic TOF, comprising at least a pair of coaxial cylinders with radial deflection and two focusing electrostatic mirrors, composed of coaxial cylinders.

13. The tandem mass spectrometer of claim 1, comprising an additional timed gate between said TOF1 and said fragmentation cell, which is capable of transmitting ions only within multiple narrow time windows.

14. The tandem mass spectrometer of claim 1, wherein energy of ion injection into said fragmentation cell is adjusted by the electrostatic offset between said TOF1 and said fragmentation cell. The offset may be adjusted during TOF1 separation to provide mass dependent ion energy around 50V/kD, optimum for parent fragmentation.

15. The tandem mass spectrometer of claim 1, wherein said fragmentation cell is collision induced dissociation (CID) cell, filled with gas and comprising at least one RF-only multipole, supplemented by at least one DC electrode.

16. The tandem mass spectrometer of claim 13, wherein the time spread of ion packet within said CID cell is reduced by using short cell of less than 1 cm long, high gas pressure above 100 mtorr.

17. The tandem mass spectrometer of claim 13, wherein for the purposes of time compression, the collision cell stores fragment ions using modulation of axial DC field within the cell, and ejects pulsed beam synchronized with TOF2 pulses.

18. The tandem mass spectrometer of claim 1, wherein said fragmentation cell comprises a pulsed temporal and spatial focusing lens and a target, coated by fluoro-hydrocarbon monolayer.

19. The tandem mass spectrometer of claim 1, wherein the TOF2 is a TOF MS with an orthogonal time injection (o-TOF MS).

20. The tandem mass spectrometer of claim 1, wherein said TOF2 comprises a high current detector and transient recorder.

21. The tandem mass spectrometer of claim 1, wherein resolution of time separation in the TOF1 is enhanced by any of the following means: any reflector of the TOF1 forms quadratic potential distribution along ion path, using large number of reflections in the TOF1, using TOF1 longer than 1 m, using said timed gate with multiple narrow time windows.

22. The tandem mass spectrometer of claim 1, wherein an additional in-line detector is installed anywhere after TOF1.

23. Method of comprehensive MS-MS analysis, comprising the following steps:

24. pulse ejection of plurality of parent ions with various mass-to-charge ratio (M/Z) out of a pulsed ion source;

25. time separation of parent ions within a first time separator;

26. fragmentation of time-separated ions;

27. mass analysis of fragment ions within a second time-of-flight mass spectrometer (TOF2);

28. Time nested fragment mass spectra acquisition corresponding to multiple parent ions per every single ion pulse without mixing fragment spectra of different parent ions,

29. wherein for the purpose of improving sensitivity and throughput of MS-MS analysis, said time separation occurs within a time-of-flight mass spectrometer (TOF1) and wherein time of said parent ion separation significantly exceeds time of both said fragmentation and said fragment mass analysis.

30. The method of comprehensive MS-MS analysis, wherein said time of flight in the said TOF1 is at least 10 times larger than in the said TOF2.

31. The method of MS-MS analysis of claim 23, wherein the ion pulse is generated in a MALDI ion source with gas pressure from vacuum up to 100 mTorr.

32. The method of MS-MS analysis of claim 23, wherein said ion pulse is formed by pulsed ejection out of storage quadrupole, while ions are introduced into the storage quadrupole out a continuous ion source of the following list: an Electrospray source, a MALDI ion source, filled with gas at gas pressure between 10 mtorr and 1 atm, an electron impact ion source, electron impact with chemical ionization ion source, or photo ionization ion source.

33. The method of MS-MS analysis of claim 23, wherein said time separation of parent ions occurs in quadratic DC field and wherein energy of ions in said TOF1 is at least 100 times less than in said TOF2.

34. The method of MS-MS analysis of claim 26, wherein said time separation of parent ions in quadratic DC field is achieved with assistance of confining radio-frequency field in at least one dimension, orthogonal to DC field.

35. The method of MS-MS analysis of claim 27, wherein said ion confinement in RF only field is achieved along one axis, ions are injected from one end of the RF field zone and after multiple reflections in pulsed quadratic DC field are released on the other end.

36. The method of MS-MS analysis of claim 27, wherein the parent ion confinement by RF-only field is achieved along two dimensional plane. Ions are injected at small angle to TOF1 axis, which is parallel to gradient of DC field. Ions experience multiple reflections in DC field, while slowly drifting in orthogonal direction, towards the exit of RF-filed.

37. The method of MS-MS analysis of claim 23, wherein said time separation of parent ions occurs in electrostatic field and wherein the said energy of ions in the first time-of-flight separator is at least 10 times smaller than in the said second time-of-flight mass spectrometer, and wherein the said effective flight path in the said first time-of-flight separator is at least 30 times larger than in the said second time-of-flight mass spectrometer.

38. The method of MS-MS analysis of claim 23, wherein said time separation of parent ions occurs in electrostatic field, created by a pair of coaxial electrodes, and wherein ions are injected into said electrostatic field at an angle to electrode axis, and wherein disturbance of said electrostatic field at boundaries is reduced by double sided printed circuit boards.

39. The method of MS-MS analysis of claim 23, wherein said time separation of parent ions occurs in planar electrostatic field, formed by planar free flight channel and planar focusing griddles ion mirrors. Ions are injected at small angle to TOF1 axis and experience multiple bounces between mirrors.

40. The method of MS-MS analysis of claim 23, wherein said time separation of parent ions occurs in cylindrical electrostatic field, formed by multiple pairs of coaxial cylinders. In at least one pair radial field is applied. The cylindrical field between cylinders is analogous to field of claim 32. Ions are injected at small angle to TOF1 axis and experience multiple bounces between mirrors.

41. The method of MS-MS analysis of claim 23, wherein resolution of time separation in TOF1 is enhanced by sampling multiple narrow time widows before submitting ions to said fragmentation step.

42. The method of MS-MS analysis of claim 23, where said fragmentation is achieved in one of the following processes: in energetic collisions with gas, in collision with surface, by light.

43. The method of MS-MS analysis of claim 23, wherein the analysis is made in two steps: step 1 of acquiring parent mass spectrum in TOF2, while using TOF1 in a pass mode, and step 2 of sampling narrow time windows in front of collision cell, corresponding to arrival of meaningful parent ions and acquiring fragment spectra for those time windows only. Said time windows are selected on the fly, based on parent masses out of stage 1 measurements.

44. The method of MS-MS analysis of claim 23, wherein a “parent scan”, i.e. spectrum of parent ions having a predetermined set of fragment ions, is reconstructed out of a full MS/MS data set.

45. Method of LC-MS-MS analysis or LC-LC-MS-MS analysis, wherein the flow of solvent is continuously introduced out of LC into a tandem mass spectrometer of claim 1 and MS-MS data are acquired using method, described in claims 21 to 37.
